(19) United States
(12) Patent Application Publication
(10) Pub. No.: US 2007/0171984 A1
(43) Pub. Date: Jul. 26, 2007

(54) Method and related apparatus for indexing video data

(75) Inventor: Francois Audeon, Caen (FR)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/590,252

(22) PCT Filed: Feb. 16, 2005
(86) PCT No.: PCT/IB05/50588

§ 371 Date: Aug. 17, 2006

(30) Foreign Application Priority Data
Feb. 20, 2004 (EP) 0430092.6

(51) Int. Cl. H04N 7/12

(52) U.S. Cl. 375/240.26

(57) ABSTRACT

The present invention provides for a method of indexing video data (18) by the creation of a plurality of scaled-down reference pictures (24) and including the steps of creating an index file (26) comprising a plurality of compression-encoded reference frames (28), and adding the plurality of reference pictures (24) created during the recording of the video data to a respective plurality of the said compression—encoded reference frames (28), the compression-encoded reference frames (28) being capable containing a plurality of reference pictures (24) each created from a plurality of different video recordings.

The present invention relates to a method and apparatus for indexing video data so as, in particular, to provide for a so-called live video sequence thumbnails which can be viewed by a user so as to assist in their selection of a particular recorded video sequence to be replayed.

There is currently a wide variety of media upon which video sequence of moving pictures can be recorded so as to provide for the selective playback of such a sequence for entertainment, or other, purposes.

With the increased amount of data that can be recorded on such media, it becomes increasingly likely that a variety of separate video recordings, perhaps made in relation to quite different subjects, and at quite different times, will be stored on a common media and will need to be readily identified for a user so as to allow for appropriately selective playback.

Since it is recognised that employing trial and error to locate the required video sequence will prove inappropriately time consuming and inaccurate, arrangements have been provided to allow for the ready display of at least portions of a recorded video sequence so that the full video sequence can be selected on the basis of the displayed portions. Such so-called live thumbnailing is disclosed, for example, in US patent application US-A-2001/0005400 which provides for a method and apparatus for producing so-called live thumbnails, i.e. short video sequences that, on a reduced scale, serve to illustrate the content of a particular portion of the full video recording.

Such known arrangements for live thumbnailing, while representing one of a variety of appropriate arrangements for creating the required thumbnail file relating to the video recording, are however disadvantageously limited to such matters of the generation of moving thumbnail pictures.

The present invention therefore seeks to provide for a method and apparatus for indexing video data by the creation of a plurality of scaled-down reference pictures and which method and apparatus have advantages when compared with known such apparatus and methods.

According to a first aspect of the present invention, there is provided a method of indexing video data by the creation of a plurality of scaled-down reference pictures and including the steps of:
creating an index file comprising a plurality of compression-encoded reference frames; and
adding the plurality of reference pictures creating during recording of the video data to a respective plurality of the said compression—encoded reference frames,
   the compression-encoded reference frames being capable of containing a plurality of reference pictures each created from a plurality of different video recordings.

Through the creation and maintenance, of such an index file, it advantageously proves possible to generate and maintain the content of an index screen clearly illustrating a plurality of moving thumbnails each representing the content of a different video sequence.

The invention can therefore provide for a method and apparatus for the real-time generation of live video indexes for a wide variety of video-playback devices using, for example, DVD, VCD and SVCD technology including related recorders and set-top boxes.

The reference to real-time generation arises since the method and apparatus of the present invention allows for the creation and updating of the video index at the same time as a corresponding video sequence is recorded to the chosen record medium.

Preferably, the method includes the steps of associating the index file with a database arranged to describe the index layout and content.

Such an associated database can also advantageously include reference to the association between each of the plurality of sequenced scaled-down reference pictures and the corresponding recorded video data.

The associated database is advantageously provided at the same time location as the index file.

Through the combination of the index file and the associated database, synchronisation between the database entries and the corresponding encoded data can readily be achieved. Also, any required copying of the index file from one media to another is readily facilitated.

According to a particular embodiment of the present invention, the index file can comprise a predetermined number of compression-encoded reference frames and the plurality of scaled-down reference pictures comprises a corresponding plurality of such pictures.

Advantageously, the said corresponding plurality of such pictures comprises the first said plurality of pictures within the recorded sequence.

Advantageously, the plurality of reference pictures are added to the respective plurality of said compression-encoded reference frames while in the compressed domain.

The plurality of reference pictures are then advantageously added to the said compression-encoded reference frame at a position determined by the layout and/or current content of the reference frame.

Of course, it should be appreciated that the compression technology employed within the method of the present invention comprises MPEG technology such that the compression-encoded reference frames comprise MPEG encoded reference frames.

While, as noted above, the method can be arranged to provide for real-time processing, it is of course possible that the method can provide it at the end of a video data recording session such that the generation of the live thumbnails occurs subsequent to the recording of the video data.

The method also advantageously provides for steps allowing for shifting of the scaled-down reference pictures within each compression-encoded reference so as to account for deletion of associated video data from the recording medium.

Of course, through the operation and method of the present invention, it becomes readily possible to employ a display device so as to display a plurality of live thumbnails so as to allow for the readily selection of an appropriate video sequence by the user.

According to another aspect of the present invention, there is provided an apparatus for indexing video data by the creation of a plurality of scaled-encoded reference pictures, the apparatus including means for creating an index file comprising a plurality of compression-encoded reference frames, means for adding the plurality of reference pictures created during recording of the video data to a respective plurality of said compression-encoded reference frames, the compression-encoded reference frames being capable of containing a plurality of reference pictures each created from a plurality of different video recordings.

It should of course be appreciated that the apparatus according to the present invention can be adapted so as to achieve advantageous further features of the method discussed above.

The invention is now described further hereinafter by way of example only, with reference to the accompanying drawings in which:

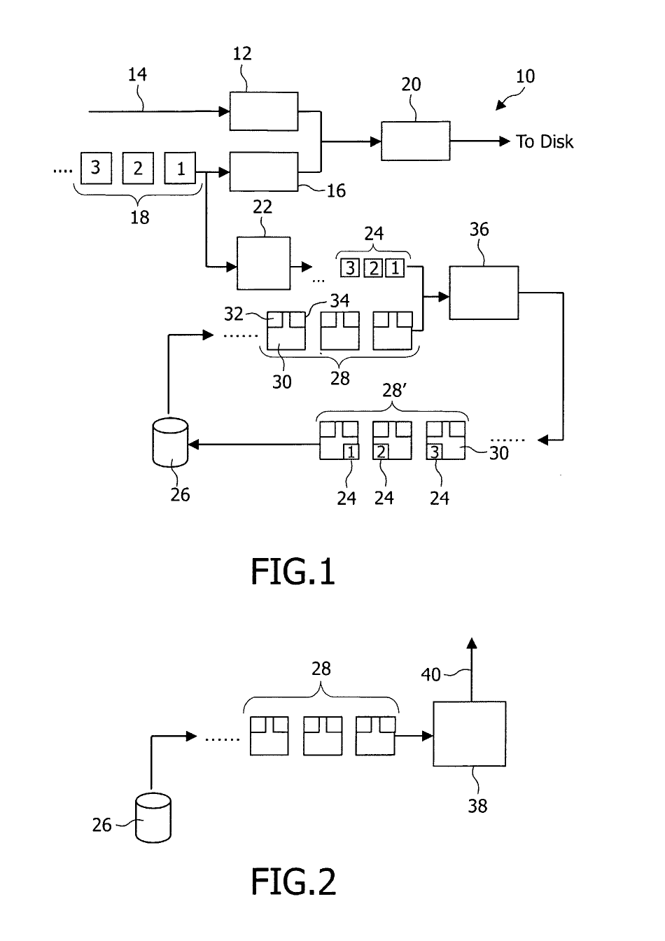

FIG. 1 is a schematic block diagram of an apparatus for indexing video data according to embodiment of the present invention; and

FIG. 2 is a schematic representation of part of the apparatus of FIG. 1 and illustrating the configuration during playback of a recorded sequence.

Turning now to FIG. 1, there is illustrated in schematic block diagram form, an apparatus 10 for indexing a video data through the creation of plurality scaled-down reference pictures.

Within the apparatus 10, there is provided an audio encoder 12 arranged for receiving the audio portion 14 of incoming audio/video signal. In parallel with the audio encoder, there is provided a suitable video encoder 16 such as an MPEG video encoder.

As illustrated, the MPEG video encoder is arranged to receive the full size baseband video pictures 18 as delivered by way of a video channel from the incoming audio/video signal.

The encoded audio and video signals are then combined by way of a multiplexer 20 and delivered to, for example, a disk drive for appropriate recording as required.

In addition to being delivered to the MPEG video coder 16, the full size baseband pictures 18 are also delivered to a scaling/encoding device 22 which, in addition to applying MPEG encoding, first serves to scale the full size baseband pictures 18 down to, for example, a quarter of their normal size as represented by the scaled pictures 24.

As part of the indexing arrangement of the illustrated embodiment of the present invention, there is provided an index file 26 from which are derived a plurality of MPEG frames 28 which are provided in the compressed domain.

Through reference to one of thirty of the MPEG frames 28, it will be appreciated that the frame 30 is arranged to contain four scaled down reference pictures of which two, 32, and 34 are illustrated within this series of MPEG frames 28.

The MPEG frames 28, and the scaled down reference pictures 24, and both delivered to a compression domain composition block 36 at which they are combined so as to introduce the scaled down reference pictures 24 to the MPEG frames 30.

This leads to the creation of an appropriate index of the full size baseband video pictures to be recorded, for example, to disks since, the combined MPEG frames 28 and scaled down reference pictures 24 are illustrated at 28′ as being delivered from the compressed domain composition block 36 to the index file 26.

In accordance with the particular embodiment of the present invention it is provided that the index file is arranged to produce a predetermined number of MPEG frames 28 and that correspondingly, the first n of the baseband video pictures 18 are delivered to the scaling/encoding block 22 so as to create n scaled-down reference pictures.

An appropriate number of MPEG frames is then produced and arranged to receive an appropriate number of scaled-down reference pictures 24.

Although illustrated in a manner so as to receive four scaled down reference pictures, each of the MPEG frames 28 is in fact arranged to receive a larger plurality of scaled-down reference pictures with the total number being dependent upon the degree to which the full size baseband video pictures can be scaled-down without disadvantageously loss in picture resolution. However, of course, since the scaled-down reference pictures are only intended to provide for a live thumbnail sequence, the resolution requirements are much less than for the full-size baseband video pictures.

Turning now to FIG. 2, there is provided a schematic block diagram so as to illustrate the manner in which the live thumbnail pictures are played for a user so as to allow for the required real-time indexing of the full video sequence which is recorded to disk.

As illustrated, the MPEG frames 28 delivered from the index file 26 and as at least part loaded with scaled-down reference pictures, is delivered to an MPEG decoded 38 for onward delivery to a rendering unit 40 such as a television monitor.

The method is based on the generation and modification of a file containing MPEG2 compliant video data representing the content of the index (the live thumbnails), and an associated database describing the index layout and content including the association between each of the live thumbnails and the corresponding movie.

Initially, the file contains n MPEG encoded reference pictures representing a fixed or moving background, where n is a configurable parameter corresponding to the total presentation time of the index screen.

During the recording of a given title on the disk/tape the first n pictures of the recording are, at the same time that they are recorded on the disk, scaled down to a specified size and encoded reference pictures.

Then, the data corresponding to each of these reduced size pictures is added in the compressed domain (at macroblock level) to the corresponding picture in the index file, at a position depending on the layout and current content (number of already recorded thumbnails) of the index screen as described in the associated database.

Method principle (in the above example the index file, originally containing two moving thumbnails, is being update with a third thumbnail, representing the move currently being recorded onto the disk).

Playing back the index. The user can select on the of recording by mean of selecting the corresponding thumbnail; how this is achieved is not part of the present invention, though the corresponding application will establish the relationship between one thumbnail and the corresponding movie by mean of the database part of the index file.

Alternatively, this processing can be ran at the end of the each movie recording (post processing) especially in case of performance constrained systems.

When a given record is suppressed from the disk, the video part of the index file is read back picture-by-picture, and each picture is updated by a block-move-like operation to shift all the thumbnails as required.

1. A method of indexing video data by the creation of a plurality of scaled-down reference pictures and including the steps of:
creating an index file comprising a plurality of compression-encoded reference frames; and
adding the plurality of reference pictures creating during recording of the video data to a respective plurality of the said compression—encoded reference frames;
the compression-encoded reference frames being capable of containing a plurality of reference pictures each created from a plurality of different video recordings.

2. A method as claimed in claim 1, wherein the index file includes the step of associating the index file with a database describing the index's layout and content.

3. A method as claimed in claim 2, wherein the associated database is arranged to define the association between a scaled-down reference picture sequence and the video data.

4. A method as claimed in claim 2, wherein the associated database is provided at the same location as the index file.

5. A method as claimed in claim 1, and including the step of providing a predetermined plurality of compression-encoded reference frames within the index file.

6. A method as claimed in claim 5, wherein a corresponding plurality of scaled-down reference pictures are extracted from the video data for addition, in a respective manner, to the plurality of compression-encoded reference frames.

7. A method as claimed in claim 1, wherein the plurality of reference pictures are added to the respective plurality of compression-encoded reference frames within the compressed domain.

8. A method as claimed in claim 1, wherein each of the plurality of reference pictures is added to the respective one of the plurality of compression-encoded reference frames at a position depending on the layout of each compression-encoded frame.

9. A method as claimed in claim 1, wherein each of the plurality of reference pictures is added to the respective one of the plurality of compression-encoded reference frames at a position depending on the current content of each compression-encoded frame.

10. A method as claimed in any one or more of the claim 1, wherein the compression-encoded reference frames comprise MPEG encoded reference frames.

11. A method as claimed in claim 1, wherein the step of the creation of the plurality of scaled-down reference pictures is conducted subsequent to the recordal of the video data.

12. A method as claimed in claim 1, and including the step of displaying a plurality of scaled-down reference picture sequences as retrieved from the plurality of compression-encoded reference frames.

13. An apparatus for indexing video data by the creation of a plurality of scaled-encoded reference pictures, the apparatus including means for creating an index file comprising a plurality of compression-encoded reference frames, means for adding the plurality of reference pictures created during recording of the video data to a respective plurality of said compression-encoded reference frames, the compression-encoded reference frames being capable of containing a plurality of reference pictures each created from a plurality of different video recordings.

14. An apparatus as claimed in claim 13, wherein the index file includes the step of associating the index file with a database describing the index's layout and content.

15. An apparatus as claimed in claim 14, wherein the associated database is arranged to define the association between a scaled-down reference picture sequence and the video data.

16. An apparatus as claimed in claim 14, wherein the associated database is provided at the same location as the index file.

17. An apparatus as claimed in claim 13, and including the step of providing a predetermined plurality of compression-encoded reference frames within the index file.

18. An apparatus as claimed in claim 17, wherein a corresponding plurality of scaled-down reference pictures are extracted from the video data for addition, in a respective manner, to the plurality of compression-encoded reference frames.

19. An apparatus as claimed in claim 13, wherein the plurality of reference pictures are added to the respective plurality of compression-encoded reference frames within the compressed domain.

20. An apparatus as claimed in claim 13, wherein each of the plurality of reference pictures is added to the respective one of the plurality of compression-encoded reference frames at a position depending on the layout of each compression-encoded frame.

21. An apparatus as claimed in claim 13, wherein each of the plurality of reference pictures is added to the respective one of the plurality of compression-encoded reference frames at a position depending on the current content of each compression-encoded frame.

22. An apparatus as claimed in claim 1, wherein the compression-encoded reference frames comprise MPEG encoded reference frames.

23. An apparatus as claimed in claim 1, wherein the step of the creation of the plurality of scaled-down reference pictures is conducted subsequent to the recordal of the video data.

24. An apparatus as claimed in claim 1, and including the step of displaying a plurality of scaled-down reference picture sequences as retrieved from the plurality of compression-encoded reference frames.
